(19) United States
(12) Patent Application Publication
(10) Pub. No.: US 2010/0073289 A1
(43) Pub. Date: Mar. 25, 2010

(54) 3D CONTROL OF DATA PROCESSING THROUGH HANDHELD POINTING DEVICE

(75) Inventor: Jan Kneissler, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/515,415

(22) PCT Filed: Nov. 27, 2007
(86) PCT No.: PCT/IB07/54794

§ 371 Date: May 19, 2009

(30) Foreign Application Priority Data
Nov. 27, 2006 (EP) 06124839.9

(51) Int. Cl. G06F 3/033

(52) U.S. Cl. 345/158

(57) ABSTRACT

A handheld pointer device provides radiation with a directional characteristic relative to its main axis. The radiation is detected by at least two detectors at different positions. This enables determining the orientation of the main axis as well as the displacement of the device along its main axis for 3D control of an object rendered on the screen of a display monitor.

### FIELD OF THE INVENTION

The invention relates to a data processing system comprising a handheld pointing device providing radiation with a directional characteristic for generating input to the system dependent on the directional characteristic. The invention further relates to a method for user control of the data processing through the pointing device.

### BACKGROUND ART

U.S. Pat. No. 5,949,402 discloses a pointing device with four LEDs (light-emitting diodes) in a specific spatial configuration. A lens at the pointing device refracts the light emitted by each specific one of the LEDs in a specific direction that is different from the directions wherein the light of the other LEDs is being refracted. A light detector receives the light beam emitted by the pointing device. The pointing angles of the device, i.e., the relative orientation of the device with respect to the receiver, can be calculated by taking the ratios of the pulse amplitudes of the LEDs. These pointing angles can then be used to position a cursor on a display screen.

U.S. Pat. No. 5,023,943 discloses a pointing device with three LEDs that have different radiation patterns. The centrally placed LED is a reference LED. It is unshielded and has a relatively flat light intensity profile. A first one of the remaining two LEDs is partially shielded in a first direction. As a result, this LED has a radiation pattern in this first direction different from the patterns of the reference LED and the second one of the remaining two LEDs. The second LED is partially shielded in a second direction perpendicular to the first direction. As a result, this second LED has a radiation pattern in the second direction different from the pattern of the reference LED and of the first LED. A receiver receiving the light from the pointing device determines the orientation of the pointing device based on the difference of the light intensities received from the reference LED and the first LED and the difference of the light intensities received from the reference LED and the second LEDs.

U.S. Pat. No. 5,627,565 discloses a space coordinates detecting device wherein a detecting section for detecting light emitted from a light source is provided, thereby permitting detection of a relative angle between a light emitting sections and the detecting section and hence permitting application of the detecting device to an input apparatus. The detecting section is provided with a light sensing element having quartered light sensing portions. In the light emitting section, distinguishable lights are emitted from two light sources. The lights thus emitted are throttled through apertures and applied as separate, square light spots to the light-sensitive surface of the light sensing element. By calculating a difference in the detected output among the quartered light sensing portions, it is possible to determine the centers of the square light spots. A relative rotational angle of the light emitting section and the detecting section with respect to a Z axis can be determined by calculating an inclination angle on X-Y orthogonal coordinates of a line connecting both centers. The light emitting section and the detecting section may be disposed on the handheld operating member and the stationary apparatus, respectively or vice versa. It is also possible to determine the distance L in the Z axis direction between the light emitting section and the detecting section. This information is used to prevent the operator from feeling a difference in the operation touch between the case where the operating member is close to the screen and the case where it is positioned away from the screen. That is, if the cursor mark is moved on the screen on the basis of only the inclination angles in the x- and y-directions of the operating member, then there is no difference in the displacement of the cursor between the case where the operating member is inclined in the x-direction in a position close to the screen and the case where the operating member is inclined by the same angle in the x-direction in a position spaced sufficiently from the screen. Therefore, when the operating member is tilted in a position away from the screen, there is created a feeling that the cursor mark does not move so much on the screen. In view of this point, if there is made correction in such a manner that with increase in the distance L between the light emitting section and the detecting section, the moving distance of the cursor mark on the screen becomes longer relative to the tilting of the operating member in the x- or y-direction, while taking into account the distance L which has been calculated, then it is possible to compensate for the difference in the operation touch between the case where the operating member is close to the screen and the case where it is spaced apart from the screen.

### SUMMARY OF THE INVENTION

The known systems enable 2-dimensional user input in dependence on an orientation of the pointing device relative to a screen of a display monitor so as to control a position of a cursor on the screen. The known systems do not enable user input as a result of a displacement of the pointing device along its main axis, i.e., a displacement of the device substantially towards or away from the screen to control a degree of freedom of an object rendered on the screen of a display monitor, in addition to the degrees of freedom within the plane of the screen.

The invention therefore provides a data processing system comprising a handheld pointing device for providing a radiation pattern with a directional characteristic relative to a main axis of the device; detection means for detecting the radiation; and calculation means connected to the detection means. The calculation means determines an indication representative of a displacement of the pointing device along its main axis based on a first curve of possible positions of the pointing device and a second curve of possible other positions of the pointing device, and uses the indication as user input for user control of the data processing.

Based on the directional characteristics of the radiation detected, the orientation of the pointing device can be determined. Without further information, the location of the device cannot be ascertained as the possible locations corresponding to this orientation lie on a curve. Moving the pointing device in a direction parallel to its main axis generates one or more other curves of new locations. In practice, the pointing device will be located in a relatively small sector of the half space defined by the plane of the screen. Using this assumption enables to calculate the displacement and to use this quantity as a user input. Note that the term “curve” in the English language covers the concept of a line that deviates from straightness in a smooth, continuous fashion, as well as the concept of a surface that deviates from planarity in a smooth continuous fashion.

The invention further relates to an apparatus comprising detection means for detecting radiation from a handheld pointing device having a radiation pattern with a directional characteristic relative to a main axis of the pointing device; and calculation means connected to the detection means. The calculation means is operative to determine an indication representative of a displacement of the pointing device along its main axis based on a first curve of possible positions of the pointing device and a second curve of possible other positions of the pointing device; and use the indication as user input for user control of the data processing. Such an apparatus is a commercial entity that can be exploited separately from the pointing device providing the radiation with the directional characteristic.

The invention also relates to calculation means having an input for receiving information representative of radiation from a handheld pointing device, wherein the radiation has a radiation pattern with a directional characteristic relative to a main axis of the pointing device; and an output. The calculation means is operative to determine an indication representative of a displacement of the pointing device along its main axis based on a first curve of possible positions of the pointing device and a second curve of possible other positions of the pointing device; and to provide at the output the indication representative of user input for user control of data processing. The calculation means is an entity that can be exploited commercially independent of the detection means and the pointing device, e.g., as an after-market add on. The calculation means can be implemented as an electronic device to be installed in, e.g., a PC, a set-top box or a television set, or in professional information processing systems for facilitating user interaction with, e.g., virtual objects rendered on s display monitor. The calculation means can also be embodied in software, e.g., for being downloaded on a PC.

Further features are addressed in the dependent claims.

For completeness, the following publications are mentioned and are incorporated herein by reference:

U.S. Pat. No. 7,102,616 discloses a hand held remote control device that allows a user to select the position and movement of a cursor on a display screen or other selected functions by rotating or translating the input device in three-dimensional space. A signal is emitted from a stationary beacon at a first location and is received by the remote control device at a second location. The remote control device detects, about two non-parallel axes, components of an angular displacement between the incident direction of the signal and a selected axis of the remote control device. Optical structures, such as cylindrical lenses, are used to project portions of the signal onto detectors in order to measure the angular displacement. Information corresponding to the detected angular displacement is transmitted to a control box, which controls the position and movement of the cursor on the display screen in response to the transmitted information. Here, the remote control is the detector and has to have onboard data processing facilities to generate data that is thereupon transmitted to the stationary portion of the system as user input.

U.S. Pat. No. 6,724,368 (Philips Electronics) discloses a system and method for controlling the movement of a cursor on a monitor screen. The system has at least one remote control unit having a plurality of push buttons for remotely controlling the moving direction of the cursor on the monitor screen. The system also has at least one light emitting element for emitting light that indicates a signal generated by the remote control unit, a light detector for extracting the light movement that is transmitted sequentially from the remote control unit; and a control unit for displaying the moving position of the cursor on the monitor screen corresponding to the extracted movement of the light from the remote control unit. The system is adapted to stop the moving of the position of the cursor upon releasing the push button of the remote control unit. The movement of the cursor on the monitor screen also can be stopped if the light movement transmitted from the remote control unit changes in the opposite direction.

### BRIEF DESCRIPTION OF THE DRAWING

The invention is explained in further detail, by way of example and with reference to the accompanying drawing, wherein:

FIG. 1 is a diagram of a data processing system in the invention;

FIG. 2 is a diagram illustrating the determining of the orientation of the pointing device in the system of the invention;

FIGS. 3 and 4 are diagrams illustrating the determining of the displacement of the pointing device along its main axis in the system of the invention;

FIG. 5 is a table with mathematical formulae used within the context of FIGS. 3 and 4.

Throughout the Figures, similar or corresponding features are indicated by same reference numerals.

### DETAILED EMBODIMENTS

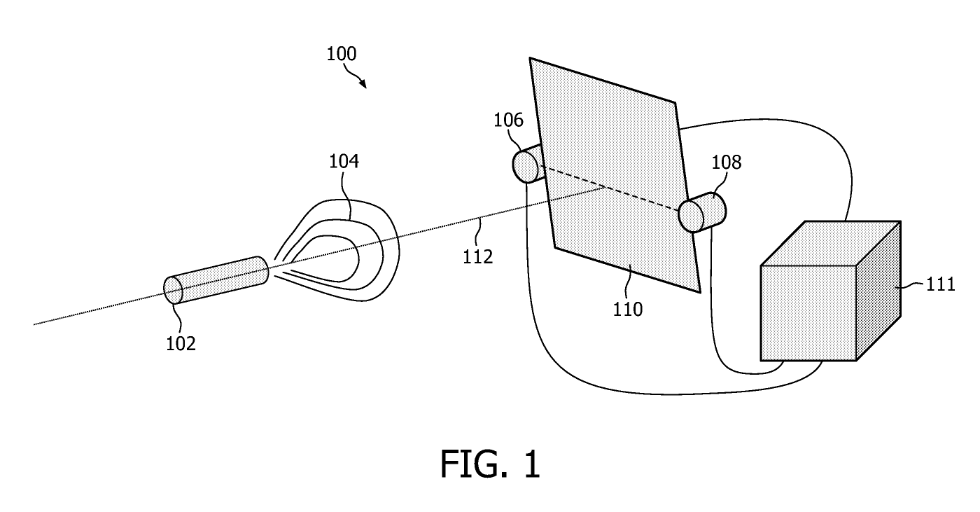

FIG. 1 is a diagram of a system 100 in the invention. System 100 has a pointing device 102 that provides radiation (e.g., visible light, infrared, radio waves, sound). The radiation has a directional characteristic 104 relative to a coordinate system fixed to device 102. That is, the radiation received at a specific location is indicative of an orientation of device 102, e.g., of its main axis, relative to that location.

Examples of such a pointing device are described in, e.g., U.S. Pat. No. 5,949,402 and in non-pre-published European patent application no. 6111205 (attorney docket PH 004968 EP1), filed Mar. 15, 2006, both incorporated herein by reference. The pointing device in European patent application no. 6111205 comprises two light sources along a first axis and two other light sources along a second axis perpendicular to the first axis.

Preferably, the light sources transmit modulated signals. This can be achieved using frequency multiplexing (e.g., different flashing frequencies for each light source), code multiplexing (e.g., different orthogonal codes), wavelength multiplexing (e.g., different wavelengths) or a time division multiplexing technique (e.g., different flashing times). The pointing device is used with a light detector near a screen. Calculation means is provided to determine in what direction a user is pointing the device with respect to the screen. The light sources all point in substantially the same direction along a third axis perpendicular to the first and second axes. The pointing device comprises shielding means for partly shielding the light emitted by the light sources. The shielding works in such a way that it causes differences in light received at the detector if the direction of the main axis of the pointing device deviates from the beeline between the pointing device and the detector. These differences are indicative of this deviation so that the pointing direction can be determined. This direction and changes therein can then be used to control cursor movement on a screen of a display monitor or to select from a menu in a graphical user interface, etc. The system in European patent application no. 6111205 needs only a single detector for determining the pointing direction when cooperating with the pointing device as described.

System 100 of the current invention comprises detection means, here detectors 106 and 108, that are operative to detect the radiation. Owing to the radiation's directional characteristic 104, detectors 106 can be relatively simple and system 100 is capable of determining the orientation of device 102 relative to any single one of detectors 106 and 108 as described in European patent application no. 6111205. Detector 106 receives radiation 104 determined by the orientation of device 102 relative to detector 106, and detector 108 receives radiation 104 determined by the orientation of device 102 relative to detector 108. This orientation information can then be used to determine the position in a screen of display monitor 110 at which device 102 is pointing in operational use. Change of the orientation is then used to position an object, e.g., a cursor, on the screen. System 100 further comprises calculation means 111 for processing the information from detectors 106 and 108 and controlling the object rendered on display monitor 110. Calculation means can include, e.g., a PC, a set-top box, a dedicated electronic circuit for use in a display monitor, etc. Accordingly, system 100 is operative to enable position control in the plane of a screen 110 in dependence of an orientation of device 102 when manipulated by a user. The orientation or changes therein serve as data input. In addition, owing to the presence of a second detector in the invention, system 100 also enables the user to input data in dependence on a change in position of device 102 in a direction substantially along a main axis 112 of device 102 or substantially perpendicular to a display monitor's screen 110 in operational use of the invention as is explained below.

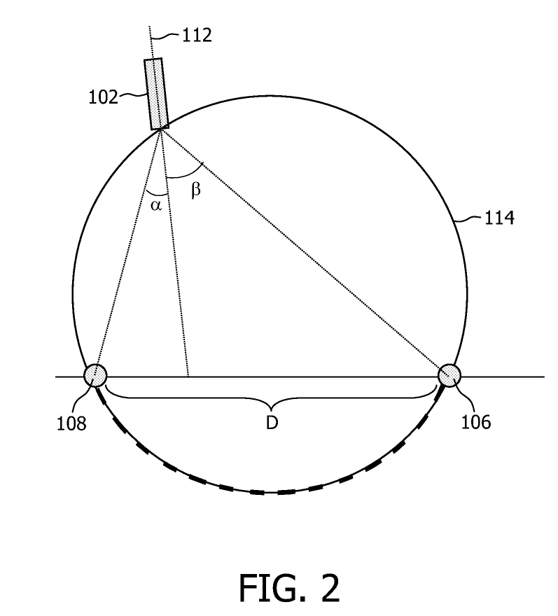

FIG. 2 is a diagram illustrating the geometry of the configuration of system 100. Detector 106 receives radiation from device 102 that is emitted at an angle β relative to a main axis 112 of device 102. Detector 108 receives radiation from device 102 that is transmitted at an angle α with respect to axis 112. Accordingly, the orientation of main axis 112 of device 102 relative to detectors 106 and 108 can be determined. It is not possible, however, to determine the position of device 102 relative to detectors 106 and 108. To see this, consider the theorem on the loci of equi-angular points (consequence of Proposition 20 in Euclid's elements, book III). This theorem says: given a line segment AB, the loci of points P such that the angle APB has a constant value are circular arcs that pass through the points A and B. In general, if AB is any chord of a circle, the angle APB for any point P on the circle is constant except at the singular points A and B themselves. Note that if the chord is not a diameter of the circle, the constant angle will be different on either side of the chord. Accordingly, a curve 114, defined by the positions of detectors 106 and 108, and of device 102, indicates the possible positions of device 102 at which it can assume an orientation with constant value of angle α and constant value of angle β. Note that curve 114 is depicted as a circular arc. The arc represents the intersection of a curved surface of the possible positions and the plane defined by detectors 106 and 108, and by the position of device 102. A third detector (not shown), positioned outside the plane defined by the positions of detectors 106 and 108 and of device 102, could be used to construct three curved surfaces, each different one associated with a different pair of detectors, representative of possible positions of device 102. The intersection of the three curved surfaces gives two locations for the position of device 102. The line-of-sight constraint allows discarding the location behind screen 110. In the remainder of this text, the terms “curve” and “arc” are being used interchangeably.

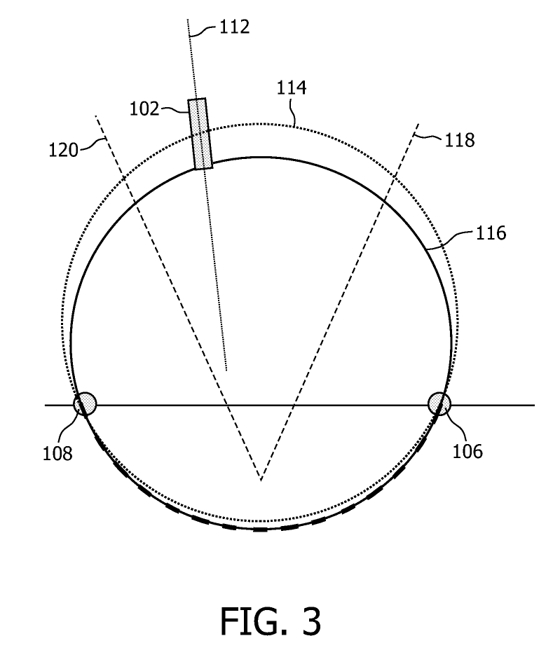

Under practical circumstances, wherein screen 110 is a display monitor and device 102 is being used to position a cursor rendered at display monitor 110, the user is typically located far away from monitor 110 (multiple times a characteristic dimension of monitor 110), main axis 112 of device 102 more or less intersecting screen 110 at its center and at a right angle. Accordingly, it is reasonable to assume that device 102 is kept located so that main axis 112 coincides with the optical axis of system 100 in operational use. As a result, the difference between angles α and β and the difference's polarity can be used to determine a change in distance between device 102 and screen 110. Note that at least two detectors are needed for this. If only a single detector were used, the change in the light received could be interpreted by system 100 as a change in orientation of device 102. This change in distance, as a result of pushing device 102 towards screen 110 or pulling it away from screen 110, while maintaining the orientation of device 102, is now used as data input as is explained with reference to FIG. 3. Accordingly, in addition to the one- or two-dimensional control of a position in the plane of screen 110, a further degree of control is provided, e.g., for selecting a specific one of multiple overlapping windows rendered on screen 110. For examples of input devices to provide three-dimensional control, see, e.g., U.S. Pat. No. 5,784,052 of Philips Electronics, herein incorporated by reference.

FIG. 3 is a diagram showing arc 114 of the possible locations of device 102 when detectors 106 and 108 register an orientation of device 102 defined by a constant value of angle α and a constant value of angle β. Now assume that device is displaced toward screen 110, i.e., substantially along the direction of main axis 112, over a distance that is relatively small in comparison to a distance between device 102 and screen 110. Detectors 106 and 108 now register small changes in the orientation of main axis 112 of device 102. The set of possible new locations is now indicated by a circular arc 116, its radius and center having changed with respect to those of arc 114. The circle defining arc 116 has been indicated with a dashed line in the lower part of that circle to distinguish it more clearly from the circle defining arc 114. Now, consider the typical possible positions that lie within a sector defined by lines 118 and 120, i.e., positions that, in comparison to the distance to screen 110, are relatively close to the axis perpendicular to screen 110 at its center. Note that within this sector the distance between arcs 114 and 116 is constant in first approximation. The change in distance between arcs 114 and 116 varies much more in another sector that subtends a similar angle as the one between lines 118 and 120 and that does not overlap with the first-mentioned sector. Given the orientation of the main axis of device 102 relative to any of detectors 106 and 108, system 100 is capable of determining the radius and center of circular arc 114. In the new position, system 100 is capable of determining radius and center of circular arc 116. The difference between the radii is representative of the change in distance, and therefore of the input to system 100 generated by pushing or pulling device 102 relative to screen 110.

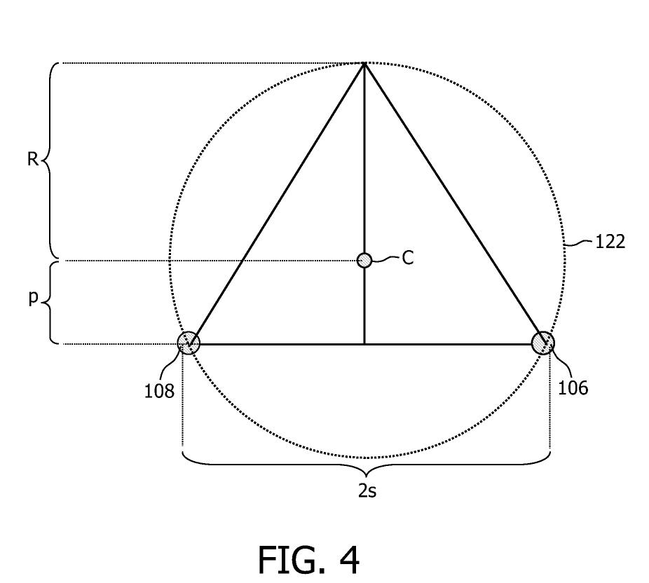

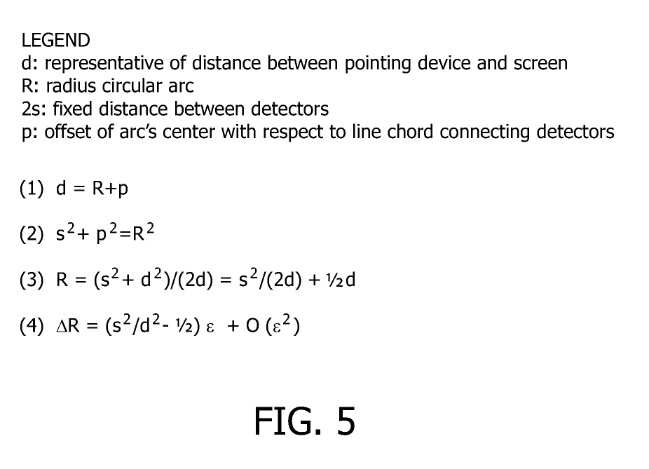

FIGS. 4 and 5 illustrate an embodiment of the invention. FIG. 4 is a diagram of a circular arc 122 defined by the positions of detectors 106 and 108, and by the possible locations of device 102 given the orientation angles as registered. The positions and angles fully define arc 122. The following features are indicated. The distance between device 102 and screen 110 is indicated by “d”. It is assumed that a fixed value for “d” is accurate enough for positions considered within the sector defined by lines 118 and 120 as discussed above. The radius of arc 122 is indicated by “R”. The fixed distance between detectors 106 and 108 is labeled “2s”. The distance between center “C” of arc 122 and screen 110 is indicated by “p”. FIG. 5 gives the mathematical expressions for the derivation of a relationship between a change in radius “R” and a change in distance “d”. Formula (1) says that “d” equals the sum of “R” and “p”. Formula (2) gives the relationship between “s”, “R” and “p” according to Pythagoras' Theorem. Combining formulae (1) and (2) gives formula (3) that expresses the dependence of “R” on “s” and “d”. If the value of “d” is changed to “d−ε”, wherein “ε” is much smaller than “d”, and this is substituted into formula (3), then the change in radius is in accordance with formula (4) with an accuracy of the order of “ε”.

As a practical example, consider the value for “s” is 0.35 m and a value for “d” larger than 1.5 m. Then the proportionality between the change in radius “ΔR”, i.e., the difference in radii as determined by system 100 upon a displacement “ε”, and displacement “ε” is about 0.5. Accordingly, measuring the change in radius gives an indication of the magnitude of the displacement of device 102.

1. A data processing system (100) comprising:
a handheld pointing device (102) for providing a radiation pattern with a directional characteristic (104) relative to a main axis (112) of the device;
detection means (106, 108) for detecting the radiation;
calculation means (111) connected to the detection means and operative to:
determine an indication representative of a displacement of the pointing device along its main axis based on a first curve (114) of possible positions of the pointing device and a second curve (116) of possible other positions of the pointing device; and
use the indication as user input for user control of the data processing.

2. The system of claim 1, wherein the calculation means is operative to determine an orientation of the main axis relative to the detection means as further user input for further user control of the data processing.

3. The system of claim 1, wherein:
the calculation means comprises an output for connecting to a display monitor (110); and
the data processing comprises moving of an object rendered on a screen of the display monitor.

4. An apparatus comprising:
detection means (106, 108) for detecting radiation from a handheld pointing device (102) having a radiation pattern with a directional characteristic (104) relative to a main axis (112) of the pointing device;
calculation means (111) connected to the detection means and operative to:
determine an indication representative of a displacement of the pointing device along its main axis based on a first curve (114) of possible positions of the pointing device and a second curve (116) of possible other positions of the pointing device; and
use the indication as user input for user control of the data processing.

5. The apparatus of claim 4, wherein the calculation means is operative to determine an orientation of the main axis relative to the detection means as further user input for further user control of the data processing.

6. The apparatus of claim 4, wherein:
the calculation means comprises an output for connecting to a display monitor (110); and
the data processing comprises moving of an object rendered on a screen of the display monitor.

7. Calculation means (111) having:
an input for receiving information representative of radiation from a handheld pointing device (102), wherein the radiation has a radiation pattern with a directional characteristic (104) relative to a main axis (112) of the pointing device; and
an output;
wherein the calculation means is operative to:
determine an indication representative of a displacement of the pointing device along its main axis based on a first curve (114) of possible positions of the pointing device and a second curve (116) of possible other positions of the pointing device; and
provide at the output the indication representative of user input for user control of data processing.

8. The calculation means of claim 7, operative to determine an orientation of the main axis as further user input for further user control of the data processing.

9. The calculation means of claim 7, wherein the data processing comprises moving of an object rendered on a screen of a display monitor (110).

10. Software comprising computer-readable instructions for implementing calculation means (111) having:
an input for receiving information representative of radiation from a handheld pointing device (102), wherein the radiation has a radiation pattern with a directional characteristic (104) relative to a main axis (112) of the pointing device; and
an output;
wherein the calculation means is operative to:
determine an indication representative of a displacement of the pointing device along its main axis based on a first curve (114) of possible positions of the pointing device and a second curve (116) of possible other positions of the pointing device; and
provide at the output the indication representative of user input for user control of data processing.

11. The software of claim 10, wherein the calculation means is operative to determine an orientation of the main axis as further user input for further user control of the data processing.

12. The software of claim 10, wherein the data processing comprises moving of an object rendered on a screen of a display monitor (110).

13. A method of enabling user control of data processing through manipulation of a handheld pointing device (102) providing a radiation pattern with a directional characteristic (104) relative to a main axis (112) of the device, the method comprising:
detecting the radiation;
determining an indication representative of a displacement of the pointing device along its main axis based on a first curve (114) of possible positions of the pointing device and a second curve (116) of possible other positions of the pointing device; and
using the indication as user input for the user control of the data processing.

14. The method of claim 13, comprising determining an orientation of the main axis as further user input for further user control of the data processing.

15. The method of claim 13, wherein the data processing comprises moving of an object rendered on a screen of a display monitor (110).
